(19) United States
(12) Patent Application Publication
(10) Pub. No.: US 2001/0023184 A1
(43) Pub. Date: Sep. 20, 2001

(54) Mobile radio with adaptive recognition of idle paging messages

(76) Inventors: Hans Kalveram, Nurnberg (DE); Arthur Tritthart, Kleinsendelbach (DE)

Correspondence Address: Corporate Patent Counsel, U.S. Philips Corporation, 580 White Plains Road, Tarrytown, NY, 10591, US

(21) Appl. No.: 09/741,990

(22) Filed: Dec. 20, 2000

(30) Foreign Application Priority Data
Dec. 24, 1999 (DE) 19963040.2

(51) Int. Cl. H04Q 7/20

(52) U.S. Cl. 455/426; 455/458

(57) ABSTRACT

In receiving devices for mobile communication comprising at least one controller, an improvement of the power saving is proposed for the evaluation of paging messages divided over a plurality of paging message sub-blocks and for setting the receiving device to a power-saving mode when the paging message does not contain a predefined subscriber identity number, in that the controller compares a received paging message sub-block with a stored sample and suppresses the reception of further paging message sub-blocks of the same paging message block when the received paging message sub-block matches.

The invention relates to a receiving device for mobile communication comprising at least one controller for evaluating paging messages and for moving the receiving device to a power-saving mode.

For constant reachability, receiving devices for mobile communication are arranged so that they listen-in on messages on a certain radio channel to find out whether a connection request from another communication subscriber is signaled. If this call signaling takes place in predefined equidistant message blocks, the receiving portion and further parts of the receiving device that are not necessary can be switched off—as long as there are no other receiving tasks—until a following expected message block is received. In this way the power consumption in the so-called standby mode can be reduced.

A mobile radio receiver with an arrangement for processing paging messages is known, for example, from EP 0 655 872 A2, in which a signal processor and a microprocessor co-operate, in that the signal processor compares identity numbers contained in the received paging messages with a mobile radio identity number stored by the microprocessor in a dual port memory, and activates the microprocessor for further signal processing from a power-saving rest mode only when an identity number contained in the paging messages corresponds to the identity number stored in the dual port memory. Messages not containing any identity number, so-called idle messages, are recognized by the digital signal processor and ignored.

In certain mobile radio systems, such as the Global System for Mobile communication (GSM) meanwhile spread out over Europe, to which also the described state of the art relates, the transmission of a mobile subscriber identity is divided over a plurality of single signal bursts. In the GSM system a signal block comprising four signal bursts can contain up to four subscriber identities which are protected from transmission errors by means of a combination of block coding, convolutional coding and interleaving. A signal burst therefore contains only a certain part of a subscriber identity contained in each paging message. Therefore, for the evaluation of the subscriber identities it has so far been assumed that it is necessary to receive all four signal bursts of a paging message.

It is an object of the invention to provide a mobile radio by which in a mobile radio system where subscriber identities cannot directly be determined from the received signal, a power saving is attained.

This object is achieved by means of the characterizing features of claim 1. By comparing a paging message sub-block or a larger paging message sub-block formed by a plurality of smaller paging message sub-blocks, with a predefined sample, there may often be detected without the need that the contents of all the paging message sub-blocks be known, that the paging message sub-block received so far does not contain a subscriber identity and thus not its own subscriber identity either. Thus, in many cases, already after the reception of the first paging message sub-block, the power saving mode may be changed to, so that the standby time of the radio receiver is extended accordingly.

In the embodiment as claimed in claim 2, the first or more received paging message sub-blocks from paging messages that turn out to be idle messages are stored as new samples. In this manner the mobile radio can itself adjust to such samples. This is particularly advantageous when a certain sample is not predefined by standards. The radio can therefore adjust to any random idle paging message transmitted by a base station.

These and other aspects of the invention are apparent from and will be elucidated with reference to the embodiments described hereinafter.

In the drawings:

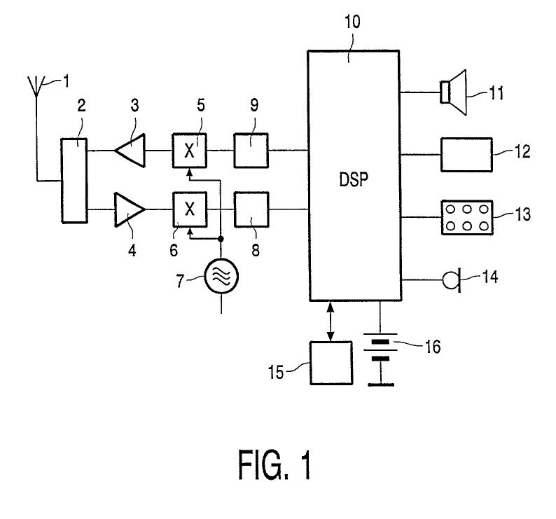

FIG. 1 shows a block diagram of a mobile radio receiver,

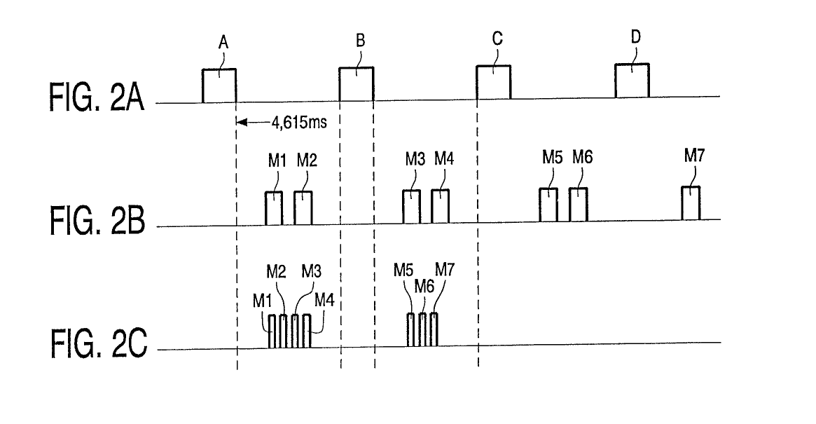

FIG. 2 shows a diagram of the broadcast channel in the GSM system, and

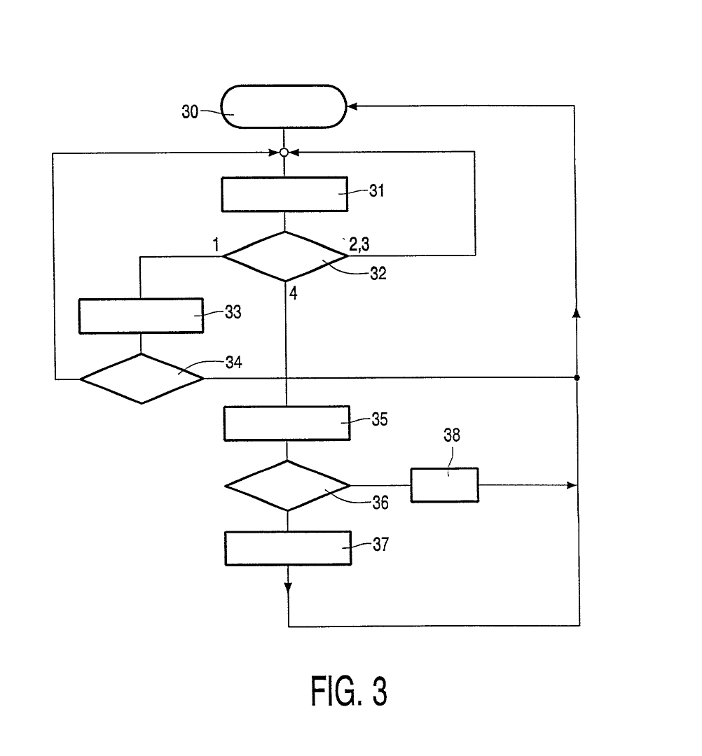

FIG. 3 shows a flow chart for processing the signal burst in accordance with a first example of embodiment.

FIG. 1 shows the block diagram of a mobile radio receiver with a transceiver antenna 1 to which are connected by a duplex switch 2 a transmitting stage 3 and a receiving stage 4. By means of a mixer 5, 6 on the receiving and transmitting sides and a controlled mixing oscillator (local oscillator) 7 the received signals are converted to the baseband or signals to be transmitted are converted from the baseband to the transmitting frequency, respectively. Received signals are demodulated in a demodulator 8 and applied to a digital processor 10 for signal processing and evaluation. Transmit signals generated by this digital processor 10 are applied to a modulator 9 which further transfers the modulated signals to the mixer 6 on the transmitting side. To the digital processor 10 are further connected a loudspeaker 11 for reproducing received audio signals, an alphanumeric display 12 for user guidance and reproduction of received non-verbal information, a keypad 13 for operating the mobile radio and a microphone 14 for capturing speech signals. Furthermore, an interface is provided for reading a memory card 15 on which, among other things, a subscriber identity assigned to the user of the mobile radio is stored, by which identity the mobile radio identifies itself in the mobile radio system.

The digital processor 10 also carries out control tasks and for this purpose includes volatile memories (not shown) for storing changeable data and non-volatile memories (not shown either) in which, for example, the control algorithms for operating the mobile radio and for the signal processing are stored. The digital processor 10 also controls the power supply of the individual modules, in particular in the interesting case at hand of saving power when messages are received in the standby mode, the power supply of power receiving stage 3, of the receiving-side mixer 5, of the modulator 8 and of the controllable local oscillator 7. For the duration of a power saving mode these modules are not supplied with the operating current and, therefore, have no energy consumption. Timely before these modules are needed for reception, these modules are connected to the power supply. The individual delays that occur between switching on of the power supply and the individual modules reaching the operating mode are to be taken into account. Since these transient periods etc. depend on the respective structure of the sub-assembly, no further details can be given. Due to the various possibilities of designing such a mobile radio, the receiving modules 3, 5, 7, 8 may only be used as an example for modules switched to the power-saving mode. In the individual case the expert himself is to decide what further modules, for example, parts of the digital processor 10 can wisely further be switched off in one of the power-saving modes.

A mobile radio registered with the GSM system, which radio is not handling a call, is in the idle mode. In the idle mode the mobile radio receives paging messages rendered available by the base station and radiated block-by-block over the broadcast control channel BCCH, which paging messages are 0.5-2.1 seconds apart. In the GSM system a paging message contains 184 bits which are referred to as information bits in the following. By adding redundancy in the channel coding, these 184 information bits are extended to 456 bits which are referred to as channel-coded bits in the following to distinguish them from the information bits. The 456 channel-coded bits are transmitted in four separate equally long so-called bursts, so that each burst contains 114 channel-coded bits. With additional so-called training and guard bits a burst lasts 0.577 ms. Each time eight time slots in which bursts are transmitted are combined to a frame in a GSM system, so that the frame duration is 4.615 ms.

The bursts, which each contain part of a paging message, are referred to as signal bursts in the following. The four signal bursts of a paging message are transmitted in the first time slot of four successive frames. FIG. 2A diagrammatically shows the distribution of the four successive signal bursts A, B, C, D in the BCCH.

In the GSM system the BCCH is continuously sent by a mobile at constant power, so that by measuring the BCCH, each mobile station can establish a reflection of its radio situation. For this purpose, the base station predefines a list of other base stations for the mobile station, which cyclically measure the mobile station. The reception of a paging message and the measuring of base stations, which idea is referred to as monitoring, are basically two independent operations. Since the mobile radio is to be switched on for reception anyway, the time between the reception of the signal burst has always been used for monitoring to achieve a favorable power consumption.

Usually, a time offset from 2.5 to 3 time slots is maintained as a distance between the reception of a signal burst and the measuring of base stations in seven measuring intervals M1, . . . , M7, so that it is possible to carry out two more measurements in each frame after a signal burst has been received. This time space between the reception of a signal burst and the measuring of base stations guarantees a respective time reserve for retuning the mixing oscillator. This time frame corresponds to the time space predefined in the GSM system for the conversation mode between the receive time slot, transmit time slot and a further time slot for measuring other base stations. The transmit time slot TX begins in a mobile station about three time slots minus a timing advance, which in the GSM system is provided for having the bursts sent by a mobile station arrive at a base station exactly three time slots after a respective burst transmitted by this base station. Accordingly, in the GSM standard the number of base stations to be measured in 2 seconds is put to seven, so that in the first three frames two and in the fourth frame only one base station is to be measured.

With the aid of the flow chart shown in FIG. 3 is described the signal evaluation implemented in the digital processor 10 for controlling the sleep mode and the power-saving mode. Timely before the reception of the first signal burst of a paging message is expected, the respectively assumed sleep mode of the mobile radio receiver adopted previously is terminated. The processing begins in FIG. 3 in the power-saving mode 30. In the example of embodiment the receiving modules 3, 5, 7, 8 are individually re-activated before the beginning of the next frame of a paging message in accordance with the re-activation time of a single module, depending on how much time there is left until the instant at which the receiver is to be ready for reception, so that the moment the first signal burst A arrives, this burst can be received (block 31) and equalized by the digital processor 10. Based on an interrogation (comparator block 32), a branch-off is made in accordance with the number of the received signal burst.

First the equalizer implemented in the digital processor (10) detects the channel-coded bits contained in the signal burst (block 33). With this example of embodiment it has proved to be sufficient to utilize a so-called Hard-Decision Detection at this point, for which only the binary values of the channel-coded bits are issued; in contrast to the SDRAM timing 2T S, in which each channel-coded bit is represented as a value that denotes the reliability with which to each detected bit can be assigned a certain binary value.

Then the channel-decoded bits are compared with a stored sample which contains the channel-coded bits of the first time slot of the idle paging message (comparator block 34). This sample may either be predefined or, as will be more accurately described hereinafter, be generated by the mobile radio or the digital processor 10 respectively of the mobile radio itself. If a match is found between the detected bits of the received first signal burst and the stored sample, the next three signal bursts of the paging message will most probably not contain a paging message. The mobile radio can therefore immediately be set to the power-saving mode 30. If, conversely, no sufficient match is established, also the next signal bursts B, C have to be received to finally, after reception of the fourth signal block D, evaluate the complete paging message to take a call for its own mobile station, or to detect in the end that the paging message did not contain its own subscriber identity after all. The power saving consequently depends on the use of the cells of the mobile radio system. The more idle messages are sent, the larger the power saving is of course.

For the evaluation of all four signal bursts, the whole message is decoded (block 35) and there is decided whether the decoded paging message contains at least one subscriber identity. If this is not the case, if it is an idle paging message which for some reason has not been recognized as such already from the first signal burst, the bit sample of which the decoding was carried out is stored as a new comparison sample (block 38) and the power-saving mode is changed to until the following first signal burst is received. In this way the receiving device automatically adapts to idle paging messages. As a result, it is furthermore possible to compare a respective section of a stored coded idle message with a received and equalized, but not yet decoded, paging message sub-block. This is particularly advantageous if—as in the present example of embodiment—with only one of four sub-blocks even under favorable conditions a decoding would not end in results that can be used.

The comparison with the stored sample may be made, for example, by comparing a received signal burst and a stored sample bit by bit, so that the number of non-corresponding bits is determined. If more than a predefined number D of bits do not correspond, it is assumed that the paging message contains at least one subscriber identity. An error-free correspondence between received signal burst and stored sample would be rarely attained due to transmission errors, so that many idle paging messages would not be accepted as such and thus the effect of power saving would be eliminated. Conversely, the rejection threshold D must not be too high, because otherwise there is a danger that signal bursts having relevant contents would be rejected as idle paging messages, which would erroneously lead to non-reachability of the radio receiver. In simulations it has turned out that for the GSM system chosen in the example of embodiment a rejection threshold D thirteen bits yields a good compromise. With the very unfavorable classic case of Urban Traffic of 50 km/h (TU 50), with a 20 dB signal-to-noise ratio, only with about every five hundredth idle paging message is the paging mode erroneously not moved to after the first sub-block has been received. With 12 dB signal-to-noise ratios, which approximately corresponds to the acceptance threshold, in nine out of ten cases an idle message can still be recognized and the power-saving mode be used. The reverse case where the one subscriber identity is erroneously interpreted as an idle message, is in all cases larger than one to 10⁵. It is up to the expert to provide, if necessary, other still further suitable rejection thresholds, for example, by utilizing the error protection of the individual bits that is different for certain bit positions.

If a non-idle paging message is recognized, the paging message is examined for its subscriber identity etc. Since this process does not differ from the state of the art, it was combined to a single processing block 37 in the example of embodiment.

A further possibility of embodiment (not shown) consists in that in a situation where the first signal burst is rejected owing to poor reception as a signal burst of an idle paging message, this comparison with a second and, if necessary, with a third received signal burst and accordingly stored samples is repeated. Although the digital processor 10 in these cases cannot switch over to the power-saving mode immediately after the evaluation of the first signal burst, there is still the chance that a signal burst not recognized as an idle signal burst is still recognized after the second or third signal burst and in this way still a power saving, albeit slightly smaller, is achieved.

A radio receiver for a GSM network is to measure also other mobile stations in the receiving mode and send the measured receiving level to its own base station. These measurements form, for example, the basis for rerouting to another radio cell (cell reselection). Usually, these measurements were made between the reception of the signal bursts. Owing to these measurements still to be made, the mobile radio cannot, however, be switched off completely, even with detected idle paging messages, until the first signal burst of the next paging message arrives.

However, it is advantageous to end all measurements after the first signal burst or at least after the second signal burst, because then the power-saving mode need not be interrupted for carrying out these measurements. The shorter, however, a measuring interval for measuring another base station, the larger the danger that the measuring results are falsified. Such a falsification may be the result of brief signal bursts or also of the so-called power ramping in which base stations lower the transmit power between the individual signal bursts and let it rise again. Therefore, to avoid such falsifications, a relatively long measuring interval has so far been chosen, so that individual signal bursts have not had much influence. On the other hand, to avoid such falsification, the example of embodiment provides that the worst measuring values, for example the worst eight, are to be rejected, that is to say, to be disregarded when the average value is calculated. A further embodiment also comprises a rejection of the poorest measuring values which are linked as a block. In this manner the length of a measuring interval can be reduced to, for example, 40 bits, so that, for example, at the instant at which a third signal burst is received already all measurements have been terminated. As a result, in case of a detected idle paging message, the receiving device can be completely switched off after the last measurement, that is, before the third signal burst is received (FIG. 2C).

It will be obvious that the described algorithm may be combined with other algorithms, for example, with the attempt at already calculating the subscriber identifications when not yet all the signal bursts of a paging message have been received. Since a decoding of the subscriber identities contained in a paging message block is possible already with two or, under moderately disturbed receiving conditions, at least with the first three paging message sub-blocks when there are good receiving ratios thanks to the error protection, a power-saving mode may thus be early switched over to in this manner when the received paging message is not an idle paging message.

The invention has been described with reference to a single digital processor, but is naturally not restricted to single-processor systems. For example, in the past it was certainly customary to divide the functions of signal processing, signal evaluation and control over a plurality of integrated modules, for example, a digital signal processor and a microprocessor. The idea of mobile radio receiver used here and the description of the example of embodiment with reference to the GSM network naturally does not restrict the invention to mobile radios for cellular networks, or the GSM network in particular. The expert can benefit from the publication for all radio communications systems in which paging messages are transmitted over time. A message may also be divided into sub-blocks on the receiving side. Since the boundaries between radio systems become ever more blurred anyway, also so-called cordless telephones should be understood to be meant by the word radio receiver. Depending on the radio system in which the invention is used, it may also be suitable to compare received paging message sub-blocks with more than only one stored sample.

1. A receiving device for mobile communication comprising at least one controller for evaluating paging messages divided over a plurality of paging message sub-blocks and for moving the receiving device to a power-saving mode when the paging message does not contain a predefined subscriber identity, characterized in that
the controller compares a received paging message sub-block with a stored sample and suppresses the reception of further paging message sub-blocks of the same paging message block when the received paging message sub-block matches.

2. A receiving device as claimed in claim 1, characterized in that
the respective paging message sub-blocks of a paging message interpreted as an idle paging message are stored as a new sample.

3. A receiving device as claimed in claim 1 or 2, characterized in that
with control measurements a number of measuring values remain discarded for the formation of the measuring result.

4. A receiving device as claimed in claim 1, 2 or 3, characterized in that
the control measurements are terminated already before the second or third paging message sub-block has arrived.
